(19) United States
(12) Patent Application Publication
(10) Pub. No.: US 2003/0156039 A1
(43) Pub. Date: Aug. 21, 2003

(54) Communications system for automatically establishing communication with a craft based upon the location of the craft

(76) Inventor: Theodore Robert Tester, Portland, CT (US)

Correspondence Address: ST. ONGE STEWARD JOHNSTON & REENS, LLC, 986 BEDFORD STREET, STAMFORD, CT, 06905-5619, US

(21) Appl. No.: 10/218,149

(22) Filed: Aug. 13, 2002

Related U.S. Application Data
(60) Provisional application No. 60/358,447, filed on Feb. 19, 2002.

(51) Int. Cl. H04Q 1/00

(52) U.S. Cl. 340/825.28

(57) ABSTRACT

An automatic communications, tracking and reservation systems for automatically establishing a wireless communications link between a facility system and a craft system to facilitate the two-way transmission of messages and information, and to initiate a reservation transaction for storing the craft in order to greatly reduce the time involved with making a reservation and for minimizing the time lost due to an interrupted communications connection.

### CROSS REFERENCE TO RELATED APPLICATION

This application claims the benefit, under 35 U.S.C. §119(e)(1), of the filing date for provisional patent application No. 60/358,447, filed Feb. 19, 2002.

### FIELD OF THE INVENTION

The invention relates to an apparatus for communicating with and tracking a craft that allows a facility and third parties to send messages to a craft based on the geographical location of the craft, and a user on the craft to send messages to the facility and third parties. Still more particularly, the system allows a craft to make a reservation at a facility via a wireless Internet connection, and provides means to resume an interrupted reservation transaction.

### BACKGROUND OF THE INVENTION

For the large boating and flying population, finding a place to dock a boat or store an aircraft can be quite challenging and time consuming. A prospective client may want a space for just part of a day, or for many days; he may need any of a variety of services, such as maintenance work, waste pumpout, fuel, laundry facilities, shower facilities, or electrical power. Further, dock spaces are not “one-size-fits-all,” as boats vary widely in length, beam and draft, and a user may desire a wetslip, a mooring, or dry dock services; similarly, aircraft spaces are not one-size-fits-all as aircraft vary in length, height, and wingspan. Presently, it is a slow, cumbersome process to complete a reservation.

Currently, in order to reserve a space, a user must telephone or radio the facility of interest, and speak with an individual who can determine whether a space is available that will accommodate the particular craft, and whether the facility can provide the desired services and/or amenities. Some facilities utilize a visual display located on the wall depicting the physical layout of the facility and indicating which spaces are presently being utilized. Unfortunately, this only answers the question of whether a spot is empty assuming it has been currently updated, and perhaps whether the space is large enough for a given craft. An individual must still check the availability of amenities and the facility's service schedule before booking the reservation. Other facilities may have their records computerized, which means that an individual has to take the appropriate information from the user, enter it into the system, and then determine whether the facility can accommodate the user's request. In either case, if the facility does not have the necessary vacancy, the user must contact another facility and start the process again. Users may have to spend large amounts of time and energy simply trying to make a reservation.

A number of automated systems for reserving parking spaces have been disclosed. For instance, U.S. Pat. No. 5,432,508 to Jackson (“the '508 patent”) describes an automated parking system for a parking garage capable of keeping track of the number of available spaces and taking reservations over the phone (using touch tones); however, unlike the challenge that boats and aircraft present, it does not matter in which space a car parks, as all spaces, with the exception of compact spaces, are the same size. A system that simply reports on vacancies and directs a driver to a vacant spot cannot be utilized for boats or aircraft, because the length, beam, and draft of a boat, or the length, height and wingspan of a plane may prevent it from using a given location. In addition, the '508 patent fails to disclose the ability to decide where to park based upon the amenities the garage offers, but instead simply discloses keeping track of unused spaces for parking. The '508 patent, therefore, fails to uniquely identify the specific vehicle so as to provide for the unique requirements of the user.

In addition, U.S. Pat. No. 5,940,481 to Zeitman (“the '481 patent”) includes the ability to reserve a parking space via telephone lines, wireless telephone links, communication network systems, such as the Internet, or citizen band radio, in which a central control unit provides a user with a map, allowing the user to choose a parking facility and reserve a space. In addition, the '481 patent discloses a system that allows the user to reserve a space at any one of a number of parking facilities rather than only a single facility. However, the '481 patent is also unusable for boats or airplanes because there is no provision for unique user requirements such as craft size and service requirements. As mentioned above, simply providing a one-size-fits-all approach will not work for boats or airplanes.

Further, U.S. Pat. No. 5,910,782 to Schmitt et al. (“the '782 patent”) includes an on-board parking system enabling users to find on-street parking. The user can initiate a request for parking where the request includes a vehicle ID number. However, the vehicle ID number is used exclusively for subscription services such as billing and does not reference the vehicle type, size, service requirements, etc. Therefore, the inability of the system to provide for the unique requirements of an individual user makes the system unusable for boats or airplanes.

In addition, to utilize systems similar to those disclosed in the '481 and the '782 patents for boats or airplanes, a wireless Internet connection would be required, whereas current wireless Internet connections are inherently unreliable. For a short and simple transaction such as reserving a car parking space, the volatility of the connection may not pose much of a problem, as restarting the reservation due to a broken Internet connection would not consume much time. However, in the case of a more involved boat docking reservation or airport reservation, a break in the connection can be time consuming.

U.S. Pat. No. 6,360,167 B1 to Millington et al. (“the '167 patent”) further presents a wireless navigation system for use with vehicles with location-based multimedia messages. The messages are all preprogrammed by the user are and stored either locally in the vehicle or remotely and transmitted to the vehicle once the system determines that the vehicle is within a geographic location. This system will act as a reminder to the user of an important message once the user is within a predetermined location. However, the '167 patent provides no means for a two-way transaction, such as a reservation based on the requests of each individual user or for two-way communication between the user and third parties. In addition, the '167 patent also fails to provide for a unique identifier, or for a means to lessen the impact of a broken wireless Internet connection to simplify and reduce the time required to make a reservation.

U.S. Pat. No. 5,938,721 to Dussell et al. (“the '721 patent”) discloses a position based personal digital assistant capable of learning a user's commuting and purchasing habits, and, for example, prompting a user to make regular purchases or deliveries when the system determines that the user is in an appropriate geographic location without requiring the user to enter a specific task description. Again, these messages are preprogrammed by the user. They are not dependent on the specific vehicle driven by the user, nor do they originate from a separate party, such as a marina or airport, desiring to send the user a message, but are merely pre-entered by the user as a reminder to himself.

The Orchid ™ vehicle telematic system by Thales Telematics (“the Orchid™ system”), discloses a system in which vehicles send position, odometer, and status information to a Hub at pre-defined times, when polled, or as a result of a vehicle event. The systems have a short text messaging service over a network, allowing the vehicle operators to stay in touch with the home base and customers (such as people receiving packages from a delivery service). Further, if the vehicle enters or leaves an area predefined by the fleet operator the system can automatically send alarm messages to the Fleet Management System. However, the Orchid™ system fails to disclose the use of a unique identifier, tailored to the unique needs of a boat or airplane user for establishing communications. Further, there are no automatic messaging capabilities to notify interested parties of the location of the vehicle via standard means, and the position-based messages do not trigger a two-way communications and/or reservation transaction. In fact, no user-specific two-way reservation transaction between the vehicle system and Hub is disclosed. In addition, the Orchid system fails to disclose a system that minimizes the impact of an interrupted reservation transaction.

What is desired is a communication/reservation apparatus, which uniquely identifies and provides for the specific requirements of the user. Further, it is necessary for the apparatus to have position based messaging with the capability of automatically contacting facilities and third parties who do not have specialized software or communications devices, in order to report the location of the craft, deliver messages from the user of the craft, and offer parties the opportunity to send messages to the craft. The messages may have multimedia capabilities beyond text: for example, the apparatus may be able to automatically send a voicemail message to a facility, or automatically send a video to the craft illustrating a recommended route. In addition, it is necessary for the apparatus to automatically prompt a user to make a reservation, to have a means for automatically accessing databases of facilities systems in order to carry out the reservation transaction, and to have a means to resume the reservation transaction at a point where any interruption may have occurred.

Current http and ftp protocols support downloading beginning with the middle of the file, allowing for the resumption of incomplete downloads, but this capability is insufficient for resuming a craft reservation transaction due to the dependence of the transaction on the requests of the user. Before continuing with an interrupted reservation, it is necessary to consider the already completed portion. U.S. Pat. No. 5,956,709 to Xue (“the '709 patent”), is intended to save bandwidth, not resume broken transactions. The '709 patent discloses a system in which forms, such as online orders, are filled out entirely on the client side and then the information is uploaded to the server. However, this system also fails to disclose the use of a unique identifier. In addition, the '709 patent system assumes that the information entered on the form is not dependent upon further information. For instance, information is entered on line 1, the information to be entered on line 2 may be limited based upon the information on line 1. Because the system disclosed in the '709 patent fails to provide for this interchange of information, it will not work for boating and aircraft applications where there are many interchanges of information.

What is desired then is to provide an apparatus for making craft reservations that will facilitate making reservations to accommodate a user's specific requirements by providing a unique identifier for the craft.

It is further desired to provide an apparatus that will expedite the reservation process by automatically transferring information about the craft to the facility so that a suitable space may be identified for the specific craft.

It is yet further desired to provide a apparatus for automatically establishing two-way communications between a facility and a craft and between third parties and a craft when it is determined that the craft is within a determined geographical location.

It is still further desired to provide an apparatus that minimizes the time lost due to an interrupted wireless connection while making a reservation.

### SUMMARY OF THE INVENTION

In accordance with the objects of the present invention, a craft communication apparatus is provided for automatically communicating with a craft, the apparatus comprising: a craft system; a craft system database accessible by said craft system for storing information related to the craft; a facility system; a facility system database accessible by said facility system for storing information related to a facility; a communication link for connecting said craft system to said facility system; an algorithm transmitted by said craft system to said facility system, the algorithm including a unique identification code for identifying the craft, a location of the craft, a timestamp, and a status code; a set of determined geographical locations; a facility signal transmitted by said facility system to said craft system subsequent to said facility system determining that the craft is within said set of determined geographical locations, for communicating messages to said craft system and for initiating a reservation transaction; and a redundant sub-routine file to log the reservation transaction, wherein if the connection between said craft system and said facility system is interrupted, upon reconnection, said redundant sub-routine file is automatically loaded onto said facility system such that the reservation transaction begins at a point in the transaction where the interruption occurred.

In a further embodiment of the present invention, a craft communication apparatus is provided for automatically communicating with a craft, the apparatus comprising: a craft system; a craft system database accessible by said craft system for storing information related to the craft; a facility system; a communication link for connecting said craft system to said facility system; and an algorithm transmitted by said craft system to said facility system including a unique identification code for identifying the craft and a location of the craft.

In still another embodiment of the present invention, a craft communication apparatus is provided for automatically communicating with a craft, the apparatus comprising: a craft system; a location system, for identifying a position of the craft; a facility system; a facility system database accessible by said facility system for storing information related to a facility; a communication link for connecting said craft system to said facility system; a set of determined geographical locations; a reservation request signal transmitted by said facility system to said craft system subsequent to said facility system determining that the craft is within said set of determined geographical locations for initiating a reservation transaction; and a redundant sub-routine file to log the reservation transaction, wherein if the connection between said craft system and said facility system is interrupted, upon reconnection, said redundant sub-routine file is automatically loaded onto said facility system such that the reservation transaction begins at a point in the transaction where the interruption occurred.

In yet another embodiment of the present invention, a method is provided for automatically communicating with a craft, the method comprising the steps of: determining the position of the craft; determining if the craft is within a set of determined geographical locations; establishing a communications connection and transmitting messages between a craft system and a facility system upon determining that the craft is within the set of determined geographical locations; and logging the communications in a voyage record file.

In still a further embodiment of the present invention, a method is provided for automatically communicating with and determining the position of a craft, the method comprising the steps of: determining the position of the craft; uniquely identifying the craft by means of a unique identification code; establishing a set of determined geographical locations; determining if the craft is within the set of determined geographical locations; establishing a communications connection between the craft and a facility system subsequent to determining that the craft is within the set of determined geographical locations; and transmitting messages between the craft and the facility system wherein the unique identification code is utilized to transmit craft-specific messages to and from the craft.

In yet a further embodiment of the present invention, a craft communication apparatus is provided for automatically communicating with a craft, the apparatus comprising: a craft system; a craft system database accessible by said craft system for storing information related to the craft; a location system, for identifying the position of the craft; a facility system; a facility system database accessible by said facility system for storing information related to a facility; a communication link for connecting said craft system to said facility system; a set of determined geographical locations; and a facility signal transmitted by said facility system to said craft system subsequent to determining that the craft is within said set of determined geographical locations, for initiating the transmission of two-way messages between said craft system and said facility system.

In another embodiment of the present invention, a craft communication apparatus is provided for automatically communicating with a craft, the apparatus comprising: a craft system; a craft system database accessible by said craft system for storing information related to the craft; a location system, for identifying the position of the craft; a facility system; a facility system database accessible by said facility system for storing information related to a facility; a communication link for connecting said craft system to said facility system; a set of determined geographical locations; a position means for determining if the craft is within said set of determined geographical locations; and an identification means for uniquely identifying the craft.

The invention and its particular features and advantages will become more apparent from the following detailed description considered with reference to the accompanying drawings.

### BRIEF DESCRIPTION OF THE DRAWINGS

FIG. 1 is a block diagram of an advantageous embodiment of the present invention illustrating an interconnection of a craft system, a designated facility system, and additional facility systems.

FIG. 2a is an illustration of a set of determined geographical locations utilized by the sub-routine of FIG. 1.

FIG. 2b is an illustration of another set of determined geographical locations utilized by the sub-routine of FIG. 1.

FIG. 2c is an illustration of two sets of determined geographical locations utilized by the sub-routine of FIG. 1.

FIG. 3 is a block diagram illustrating the system of FIG. 1 in greater detail showing the interconnection of a craft system, a designated facility system, and an additional facility system.

FIG. 4 is a block diagram illustrating the algorithm corresponding to FIG. 3 in one advantageous embodiment.

FIG. 5 a flow chart illustrating one advantageous operational sequence of the system as depicted in FIG. 3.

FIG. 5a is a continuation of the flow chart illustrating the operation of the system as depicted in FIG. 3.

FIG. 6 is a flowchart illustrating possible transaction key points corresponding to FIG. 5.

FIG. 7 is a flowchart illustrating another advantageous operational sequence of the system as depicted in FIG. 3.

FIG. 8 is a flowchart illustrating yet another advantageous operational sequence of the system as depicted in FIG. 3.

FIG. 9 is a block diagram illustrating the algorithm corresponding to FIG. 3 in another advantageous embodiment.

FIG. 10 is an illustration of the operation of the system disclosed in FIG. 3 as a boat is tracked along a particular course.

### DETAILED DESCRIPTION OF THE DRAWINGS

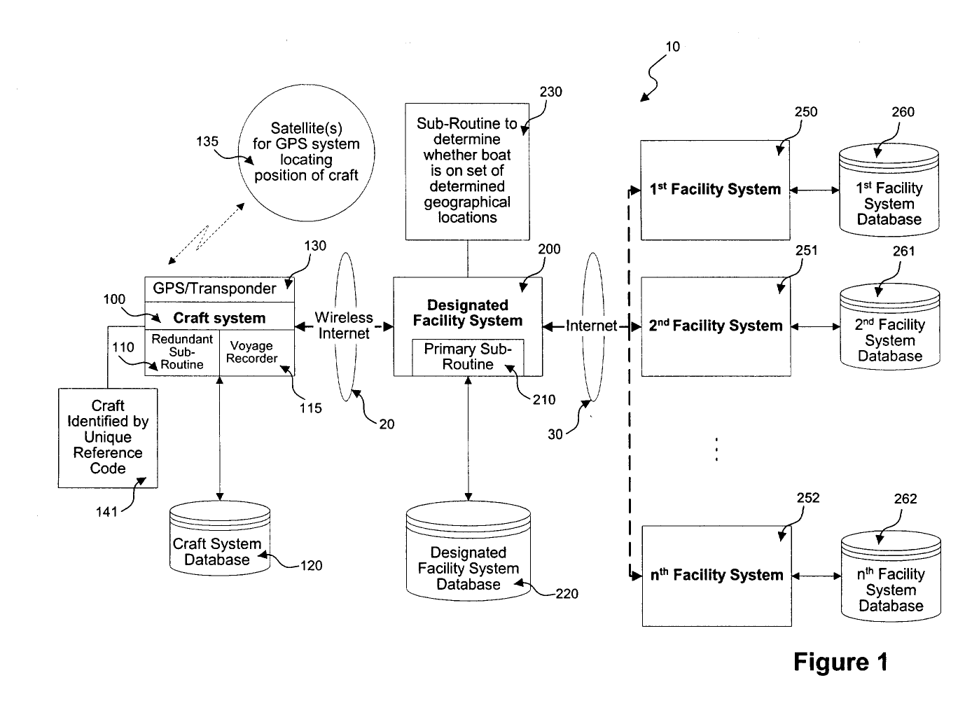

One advantageous embodiment of the present invention is illustrated in FIG. 1. The craft communication apparatus 10 includes a craft system 100, a designated facility system 200, and any number of additional facility systems, such as a first facility system 250, second facility system 251, and n^{th} facility system 252. The craft system 100, located on a craft, has access to a craft system database 120 and includes a global positioning system (“GPS”) 130, which communicates with a GPS satellite 135. The craft system 100 communicates with the designated facility system 200 via a wireless Internet connection 20, which may include a Mobile Virtual Network (MVN), a platform which allows a service to rent available wireless broadband, and add value, in this case a tracking and communication service, for its customers, but the wireless Internet connection 20 is not limited to including an MVN. The designated facility system 200 comprises a designated facility system database 220. The designated facility system may also communicate over an Internet connection 30 to any number of additional facility systems, such as a first facility system 250, having access to a first facility system database 260, a second facility system 251, having access to a second facility system database 261, and an n^{th} facility system 252, having access to an n^{th} facility system database 262. The Internet connection 30 could be any form of Internet connection, including but not limited to wireless, satellite, cable, and any number of broadband connections such as; DSL, T1, T3, and fractional-T.

Each facility system, including the designated facility system 200, can serve one or more facilities, as all that is necessary for a system to serve a facility is for the facility system to have records stored in its database indicating the capacity, amenities, service/maintenance capabilities, and reservation availability of the particular facility. As the facility systems communicate over the Internet, they can be located at any convenient location. If a user chooses to use a conventional method for making a reservation rather than utilizing the automatic reservation system, personnel may manually access the system in order to make reservations for users. The same facility system databases are accessible both automatically and manually; therefore, spaces cannot be assigned to more than one user at a time. However, since it isn't necessary to have a separate facility system at each facility to achieve the tracking and communication functionality it may be preferable to reduce costs by limiting the number of facility systems. In fact, it is possible to exclusively utilize the designated facility system 200 without any additional facility systems.

Still referring to the embodiment shown in FIG. 1, the craft with craft system 100 is identified by a unique reference code 141 (also known as a unique identification code). The unique reference code 141 may be the registration number of the craft, or any other unique identification number. The designated facility system 200 may determine when a craft identified by unique reference code 141 is within a set of determined geographical locations 230. The redundant sub-routine 110 maintained within the craft system 100, creates a redundant sub-routine file, which is effectively a backup file of a reservation transaction. The redundant sub-routine file is accessible by the craft system, but can be stored anywhere, i.e. on the craft system database 120, the designated facility system database 220, the first facility system database 260, the second facility database 261, or the n^{th} facility system database 262. If the redundant sub-routine file is stored a location other than the craft system database 120, it is necessary to link the redundant sub-routine file to the unique reference number 141 of the craft, so that when users from more than one craft try to make reservations, the redundant sub-routine files can be matched with the particular users. The primary sub-routine 210, controlled by the designated facility system 200, processes the reservation request and queries the facility system databases 260, 261, and 262. The voyage recorder 115 logs all communications in a voyage record file, which can be stored in the same manner the redundant sub-routine file. One advantage to storing the voyage record file on the designated facility system would be to limit tampering by the craft user, although it is also possible to store it as a read-only file on the craft system database 120. A tamper-proof voyage record file may act like an audit file for insurance purposes, and can help the craft owner ensure that the craft user keeps the craft on its intended course. Due to its potential importance for insurance purposes, one may store the voyage record file on both the craft system database 120 (as a read-only file) and the designated facility system database 220, or create back-ups from the main copy at predetermined times.

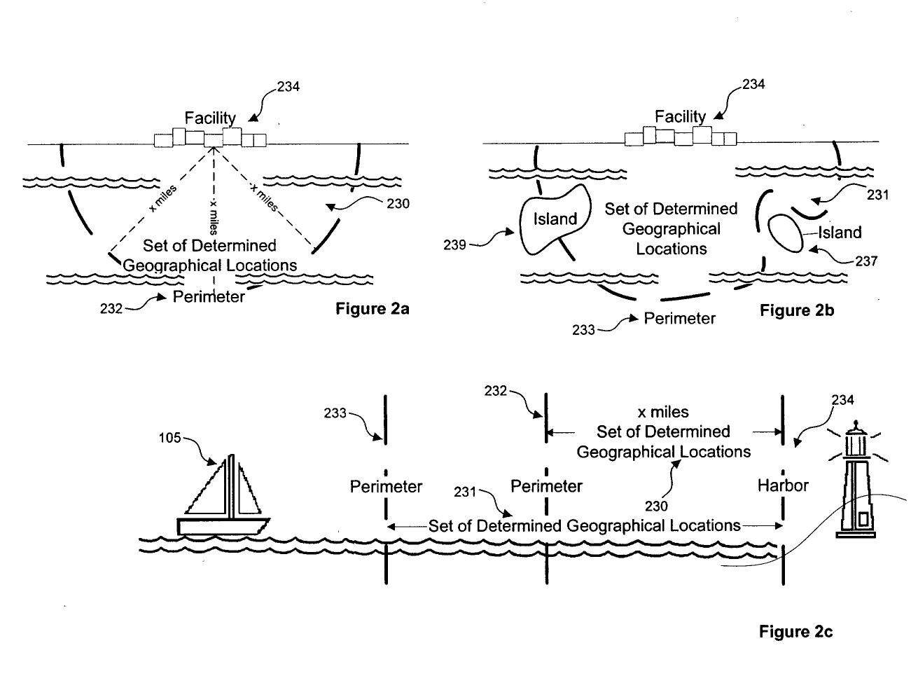

FIGS. 2a, 2b, and 2c illustrate the sets of determined geographical locations 230 and 231, having perimeters 232 and 233, respectively, the use of which will be described in conjunction with FIG. 1. The perimeter 232 is a boundary located at a fixed distance “x miles” from the facility 234, as indicated by the view in FIG. 2a. The perimeter 233 however, is an irregular boundary located at a variable distance from the facility 234, as indicated in FIG. 2b. One reason for using the irregular perimeter 233 would be to compensate for obstacles such as an island 237. As indicated by the FIG. 2b, the perimeter 233 is not required to be equidistant from the facility 234. The perimeter 232 defines the outer boundary of a set of determined geographical locations 230.

FIG. 2c shows another view of the perimeter 232 of FIG. 2a and the perimeter 233 of FIG. 2b; each perimeter defines its own set of determined geographical locations 230 and 231 respectively, and the craft 105 entering each set of determined geographical locations 230 and 231 causes the designated facility system 200 to perform an action specific to that set of determined geographical locations 230 and 231. Henceforth, the disclosure will precede using set of determined geographical locations 230 and perimeter 232 of FIG. 2a, or set of determined geographical locations 231 and perimeter 233 of FIG. 2b, as typical examples. This is not to be interpreted as limiting the discussed embodiments to a fixed-distance set of determined geographical locations rather than an irregular set of determined geographical locations. Further, although FIGS. 2a-2c depict the system as utilized for watercraft, the system may equally be utilized for use with aircraft.

One purpose of the set of determined geographical locations 230 is to act as a location-based trigger. The set of determined geographical locations 230 may be stored in the designated facility database 220. Upon determining that a craft 105, identified by its unique reference code 141, is within the set of determined geographical locations 230, the designated facility system 200 can automatically take a predetermined action. For example, the designated facility system 200 may contact the craft system 100, prompting a user to make a reservation at an available facility, and/or send a communication signal to the craft system initiating some other form of communication. The designated facility system 200 may additionally notify available facilities or other third parties that the craft 105 is within the set of determined geographical locations 230. Alternatively, the designated facility system 200 may prompt a user of the craft 105 to send messages to the facilities or third parties if a user should so desire. These are examples of some of the many actions that may occur based upon the designated facility system 200 determining that the craft 105 is within the set of determined geographical locations 230, and are not meant to be an exhaustive list.

Further, additional sets of determined geographical locations may be used to define waypoints. Waypoints are positions along a voyage at which notification of the location of the craft 105, among other information, is sent to interested parties. These sets of determined geographical locations may be near an island or the shore, but also may also enclose any determined geographical location. The waypoint sets of determined geographical locations are predetermined, so when planning a voyage, the waypoints used may be selected from a group of potential waypoints—but neither the designated facility system 200 nor the craft system 100 needs to know the waypoints selected. Whenever the craft 105 enters a waypoint, notification will be sent; so if a user desires to take advantage of a given waypoint, he or she plans the voyage to pass through the selected waypoint. For example, a craft owner may desire a waypoint to include all areas except the intended path of the craft, so that he or she can be notified if the craft user 40 should stray off-course. Alternatively, a user may file an electronic plan prior to the voyage indicating the intended path of travel including waypoints, where the waypoints may be anywhere. The electronic plan may also indicate where to send notification upon the craft 105 reaching a waypoint. In specifying the waypoints, the electronic plan effectively programs additional sets of determined geographical locations into the designated facility system 200.

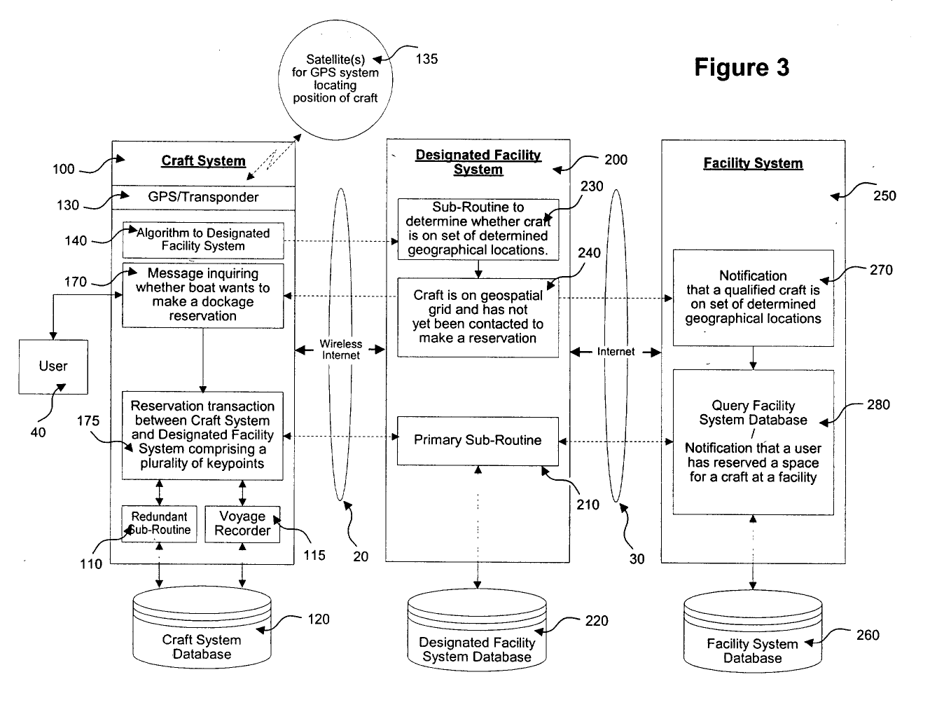

Referring now to FIG. 3 along with FIG. 2 for a more detailed illustration of the system, the craft system 100, which can access the craft system database 120, is connected to the designated facility system 200 that can access the designated facility system database 220, by wireless Internet connection 20. A user 40 may interface with the craft system via keyboard, mouse, voice-recognition means, as well as other communication means. The craft system 100 may include a video display, speakers, and an audio input device. The craft system 100 transmits a craft signal 140 to the designated facility system 200, which then determines whether the craft 105 is within the set of determined geographical locations 230. When it is determined that the craft 105 is within the set of determined geographical locations 230, and further determined that the craft 105 has not yet been contacted to make a reservation, the designated facility system 200 sends the craft system 100 a message 170 inquiring whether the user 40 of the craft 105 wants to make a reservation. The message 170 may comprise audio, video, and/or text or any combination of the foregoing. The video capabilities include but are not limited to video streaming and live or pre-recorded closed circuit television (CCTV), where video is displayed on the craft system video display.

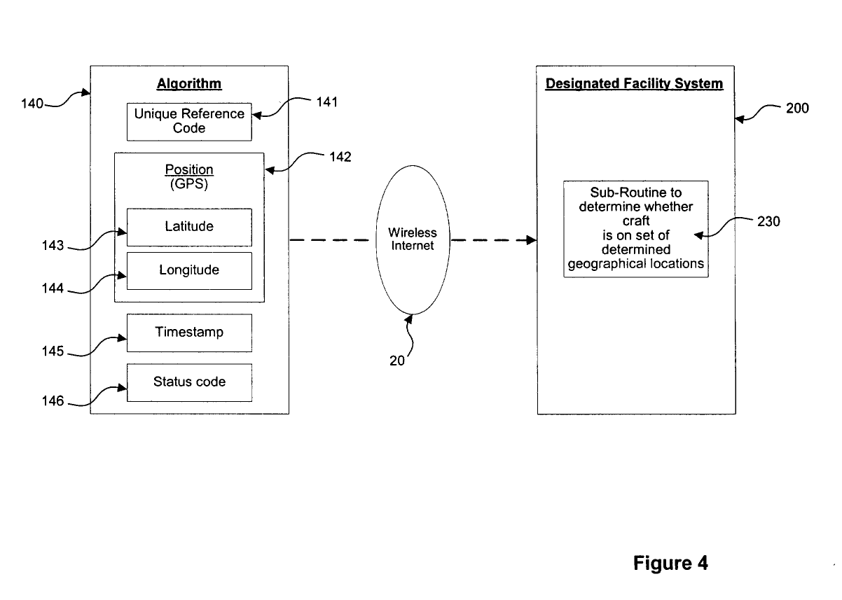

The designated facility system 200 also sends a notification 270 to interested parties, including available facilities and third parties, notifying them that the craft 105 is within the set of determined geographical locations 230. The notification 270 may be transmitted for instance, but is not limited to, via Internet messaging, wireless telephone, conventional telephone, email, fax, e-fax, network messaging, a direct wireless connection, wired or wireless CCTV, and/or other means, and may comprise audio, video, text, or a combination thereof. If there is a facility system located at each facility, then the designated facility system 200 may then send the notification 270 intended for the facilities over an Internet connection 30 directly to the facility systems (see facility systems 250, 251, . . . , 252 in FIG. 1), in addition to sending the notification 270 by any other means. Two purposes of notifying the facilities are to facilitate necessary arrangements at the facility in case the user 40 makes a reservation at the facility, and to provide the notified individuals an opportunity to prepare messages for the user 40. A third party receiving notification 270 may be the owner of the craft 105, who may not be on the voyage. The notification 270 sent to the owner (and/or others) may include for instance, but is not limited to, an estimation of an arrival time at a waypoint or a final destination. If this option is desired, it is necessary for the user 40 to file an electronic plan indicating the intended path of travel, the selected waypoints, and where to send notification. The method of computing arrival estimates will be explained in conjunction with FIG. 4.

If upon receiving the message 170, the user 40 decides to make a reservation, the reservation transaction 175 comprising a plurality of keypoints begins. When the user 40 responds to the keypoints of the reservation transaction 175, the responses are sent from the craft system 100 to the primary sub-routine 210, over the wireless Internet connection 20, which processes the responses. The means by which the user 40 can respond include typing on a keyboard into the craft system 100 and speaking into a audio input device connected (via wire or wireless means) to the craft system 100, which has speech recognition capability. The responses are also send to the redundant sub-routine 110 to create the redundant sub-routine file, which can be stored in the craft system database 120, designated facility system database 220, for instance, or facility system database 260 or any other suitable storage means. The redundant sub-routine file is used to create a backup copy of the transaction key points of the reservation transaction 175, in the event that the wireless Internet connection 20 is broken at some point before the transaction 175 is complete. The primary sub-routine 210 and redundant sub-routine 110 combine to form what is known as a dual-mode transaction processor (i.e., both a primary and a redundant sub-routine file are generated).

The designated facility system 200 communicates with the facility system 250 and queries the facility system database 260 to determine whether a facility served by the facility system 250 can fulfill the requests of the user 40. If so, the designated facility system 200 sends notification 280 to the acceptable facility that the craft 105 has made a reservation at the facility, and a space is then reserved for the craft by writing the reservation to the facility system database 260 or other suitable accessible storage means. In response to the notification 280, informed parties may make any necessary preparations and may generate and send any additional messages to the user 40. If the designated facility system 200 serves any facilities, which is not necessary, then the designated facility system 200 also queries its own database 220 to determine whether the any of the facilities it serves can fulfill the requests of the user 40; if the acceptable facility is one served by the designated facility system 200, the acceptable facility is sent notification 280 and the reservation is recorded in the designated facility system database 220. The notification 280 sent to the acceptable facility can be transmitted for instance, but is not limited to via Internet messaging, wireless telephone, conventional telephone, e-mail, fax, e-fax, network messaging, a direct wireless connection, wired or wireless CCTV, and/or other means, and may comprise audio, video, text, or any combination thereof. In the case that the facility system 250 is located at the acceptable facility, the notification 280 can be sent directly to the facility system 250 over the Internet 30, in addition to sending the notification 280 by any other means. If the designated facility system 200 is located at the acceptable facility, then the designated facility system 200 can, for example, display a message on a monitor and/or make an audio indication/notification.

The voyage recorder 115 logs all communication between the craft system 100 and the designated facility system 200 in a voyage record file. This includes all instances of the craft signal 140 being sent to the designated facility system 200, as well as all messages to and from the craft system 100. Hence, the voyage recorder 115 also logs all third party messages, as they go through the designated facility system 200 before reaching their destination. The contents of the voyage record file can be made available on the Internet in real-time to authorized parties, such as the craft owner. Video streaming can be used to display the position of the craft 105 on a chart, and messages will be available in their original format (text, audio, video, or a combination thereof). As discussed earlier, the voyage record file can be stored anywhere. Additionally, voyage record files may be archived on the designated facility system database 220, the craft system database 120, and/or the facility system database 260, so that records of prior voyages are saved and are retrievable at a later date (such as for insurance purposes). The archives files may also be made available on the web to authorized parties for download.

Notice that the designated facility system 200 may play a dual role. First, it may act as a centralized hub; regardless of the location of the craft 40, the craft system 100 sends the signal 140 to the designated facility system 200, and then the designated facility system 200 contacts the facility system 250 as necessary. For example, if the designated facility system 200 is on the west coast of the United States of America, a craft 40 in the northeast will still send the craft signal 140 to the designated facility system 200 on the west coast and complete the reservation transaction 175 through the designated facility system 200 on the west coast. Having a single designated facility system 200 is advantageous as for at least two reasons: there is no need for the craft system 100 to determine where to send the signal 140, as it is always sent to the same place, and it is possible for the craft communications, tracking and reservation system as a whole to be upgraded by installing new software on the designated facility system 200 without having to update multiple facility systems. For example, if the coverage is expanded to service a new area, the location of the new set of determined geographical locations grid only have to be programmed into the designated facility system 200. However, it is foreseeable that in a different embodiment, more than one, or even every facility system may have the capabilities of the designated facility system 200. Another advantageous embodiment of the invention (not illustrated in the drawings for simplicity) includes an online backup system for the designated facility system 200. In this case the craft system 100 may have to send the craft signal 140 to the backup system as well as the designated facility system 200. The backup system may be a system separate from any of the facility systems, or may include one of the existing facility systems. The second function of the designated facility system 200 is that it may function as a facility system in the manner of facility system 250. If the designated facility system 200 serves any facilities, when a user 40 completes a reservation transaction 175, the designated facility system database 220 is queried along with the database 260 of the facility system 250 to find a space for the user 40.

FIG. 4 illustrates the algorithm 140 sent from the craft system 100 to the designated facility system 200 via wireless Internet connection 20. Algorithm 140 to the designated facility system 200 utilized algorithm, identify the craft 105, determines whether the craft 105 is within the set of determined geographical locations 230, and determine the craft status. In this embodiment the algorithm 140 and contains four elements: a unique reference code 141, a position fix 142, and a timestamp 145, and a status code 146. As before, the unique reference code 141 may be the registration number of the craft 105 or any other unique reference number, but may also be a non-numeric identification code. In this embodiment the position fix 142 comprises the latitude 143 and longitude 144 of the craft (and possibly altitude for aircraft), although the specific format of the position fix 142 may vary. The time stamp 145 is used for instance, for billing purposes, arrival estimates, and notification purposes. Upon receiving this algorithm 140, the designated facility system 200 may then determine whether the craft is within the set of determined geographical locations 230. This determination is accomplished by comparing the position fix 142 reported by the craft to the known set of determined geographical locations 230, which is stored in the designated facility system database 220. The status code 146 allows the designated facility system 200 to distinguish between at least the following three possibilities: the craft 105 has not yet been contacted to make a reservation, the craft 105 is currently in the middle of the reservation transaction 175, and the craft 105 has completed the reservation transaction 175. Given that the craft 105 is within the set of determined geographical locations 230, the designated facility system 200 will act appropriately according to the status code 146. If the user 40 of the craft 105 has not yet been contacted to make a reservation, then the designated facility system 200 will do so. If the user 40 of the craft 105 is in the middle of the reservation transaction 175, the transaction 175 will continue or be resumed. If the user 40 of the craft 105 has completed the reservation transaction 175, whether the user 40 has made a reservation or declined to make a reservation, the designated facility system 200 will not continually contact the craft system 100 prompting the user 40 to make a reservation.

By identifying the craft 105 and providing its location 142 to the designated facility system 200, the algorithm 140 allows for a notification/messaging system, in which the designated facility system 200 serves as a gateway for messages between interested parties such as facilities and third parties, and the user 40. Upon receiving the algorithm 140, the designated facility system 200 can automatically notify interested parties of the location of the craft 105, and the interested parties can send individualized messages to the user 40 via the designated facility system 200, which then forwards the messages to the user 40. The algorithm 140 could also be used to compute arrival estimates for future waypoints or the final destination. To compute an arrival estimate it is necessary to determine the craft speed 40. This can be estimated based on the expected itinerary detailed in the electronic plan or the specifications of the craft 40, or calculated using two or more instances of the algorithm 140. As part of the messaging system, the user 40 may continuously respond or send new messages to third parties via the designated facility system 200, which will forward them to the intended parties.

As a further part of the notification/messaging system, the algorithm 140 allows the designated facility system 200 or facility system 250 through the designated facility system 200 to send individualized messages to the craft 105, such as those aiding the user 40 in his or her travels. For example, the designated facility system 200 or facility system 250 may utilize the video streaming or CCTV features to show the user 40 the best approach into the facility at which the user 40 made a reservation. This video stream may be customized based on the size of the craft 105, determined from the unique reference code 141 (FIG. 4) of the algorithm 140, and weather conditions. The video stream may be a saved video clip, or it may make use of the position fix 142 of the algorithm 140 as in FIG. 4, and adapt to the current position of craft 105. The message 170 from the designated facility system 200 asking the user 40 to make a reservation is another algorithm-triggered message.

Additionally, it is anticipated that the embodiment of the craft communications, tracking and reservation system being described will be a subscription or member service, with the algorithm 140 serving as the identifying means for the craft 105 and customer. When the designated facility system 200 receives the algorithm 140 with the unique identification code 141, it queries designated facility system database 220 for the record of the craft, which contains information relating to the length, beam, and draft of the watercraft or length, height and wingspan of the aircraft. Therefore, when completing the keypoints, it is unnecessary for the user 40 to provide this information thereby speeding the reservation process. Further, the craft record may include payment information, such as a credit card number, debit card number, or checking account number, allowing for automatic payment. The timestamp 145 can be used as a meter to determine how long the user 40 used the service, as it may be desired to bill the user 40 on the basis of time. Alternatively, the user 40 may be billed on a per transaction basis.

In the previously disclosed embodiments, the craft system 100 sends the algorithm 140 to the designated facility system 200, which then determines whether the craft 105 is on the set of determined geographical locations 230 by comparing the position 142 of the craft 105 to the location of the set of determined geographical locations 230, stored in the designated facility system database 220. It is conceivable that in other embodiments the craft system 100 may make the determination as to whether the craft 105 is on any set of determined geographical locations, and send information as to whether the craft 105 is on one of the sets of determined geographical locations, and if so which set of determined geographical locations craft 105 is on, as part of the status code 146. In this case, the set of determined geographical locations 230 may be stored on the craft system database 120. Further, it is foreseeable that the user 40 may file an electronic plan with the designated facility system 200 prior to embarking on the voyage, and in response the designated facility system 200 may send the craft system 100 the location of any relevant set of determined geographical locations for storage on the craft system database 120. If any user-defined set of determined geographical locations 230 are used, such as waypoints not selected from the predetermined waypoints, then the set of determined geographical locations 230 may also be stored in the craft system database 120. In these embodiments, the craft system 100 still sends the algorithm 140 to the designated facility system 200 according to predetermined criteria, so that the designated facility system 200 may appropriately respond when the craft 105 is on the set of determined geographical locations 230, as indicated by status code 146, and so the designated facility system 200 may make the voyage record file available online to authorized parties and perform other tracking and communication functions as necessary. For example, upon being informed by the craft system 100 that the craft 105 is on the set of determined geographical locations 230, the designated facility system 200 can prompt the user 40 of the craft system 100 to complete a reservation transaction. Alternatively, the craft system 100 may prompt the user 40 to begin a reservation transaction, and then notify the facility system 200 if the user 40 decides to make a reservation.

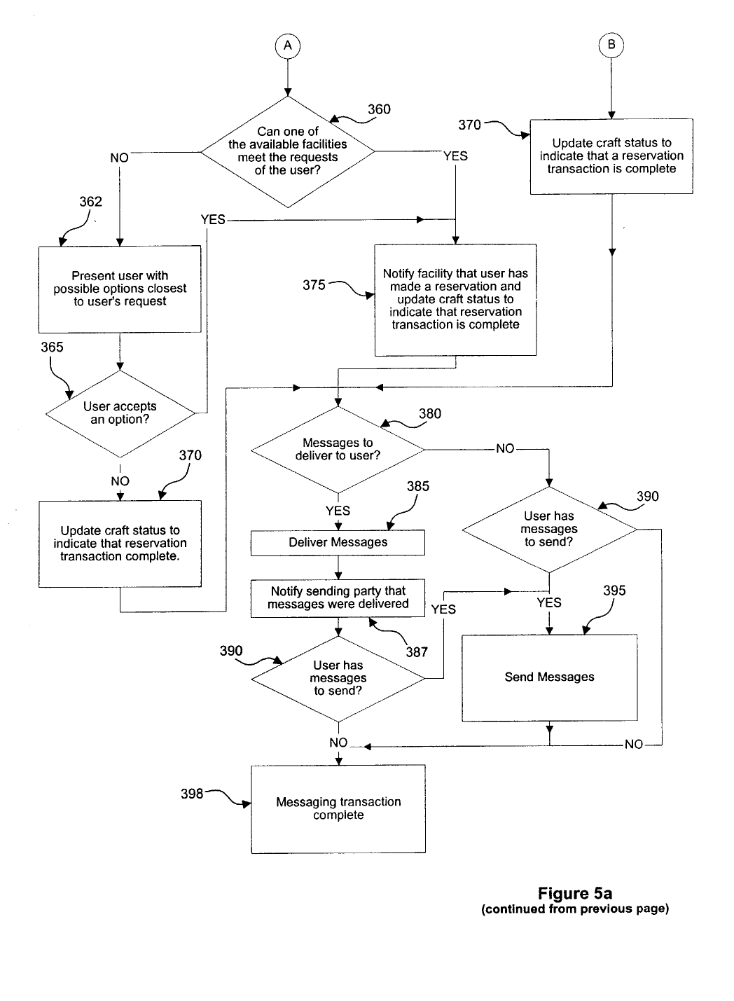

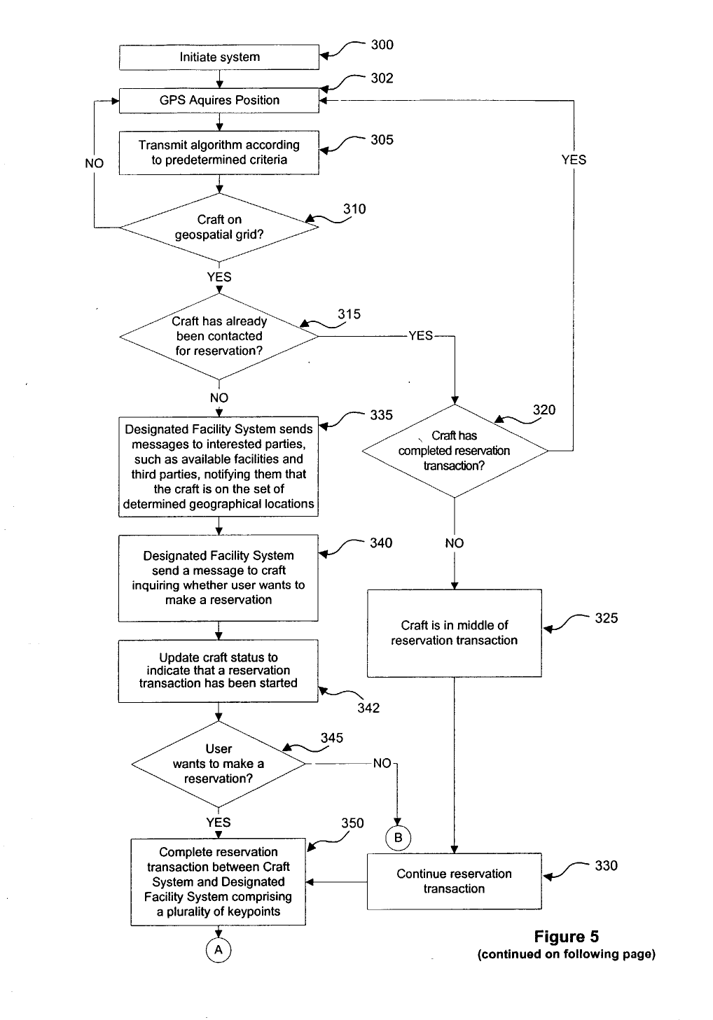

Referring now to FIG. 5, the system is initiated 300 and the GPS system acquires 302 the position 142 of the craft 105. Although the embodiment illustrated in FIG. 5 describes the use of a GPS system 130 and satellite 135, any other positioning system may be utilized. The craft 105 subsequently transmits 305 the craft signal 140 according to predetermined criteria, such as transmitting continuously or at a fixed time or position interval. The timestamp 145 may be used for billing and notification purposes, as previously explained. Based on the information contained in the algorithm 140, the designated facility system 200 then determines 310 whether the craft 105 is within the set of determined geographical locations 230. In an alternative embodiment, the location of the set of determined geographical locations 230 is stored on the craft system database 120, and the craft system 100 determines whether the craft 105 is on the set of determined geographical locations 230, and reports to the facility system 200 whether the craft 105 is on the set of determined geographical locations 230 through a status code 146 which may be part of the craft signal 140.

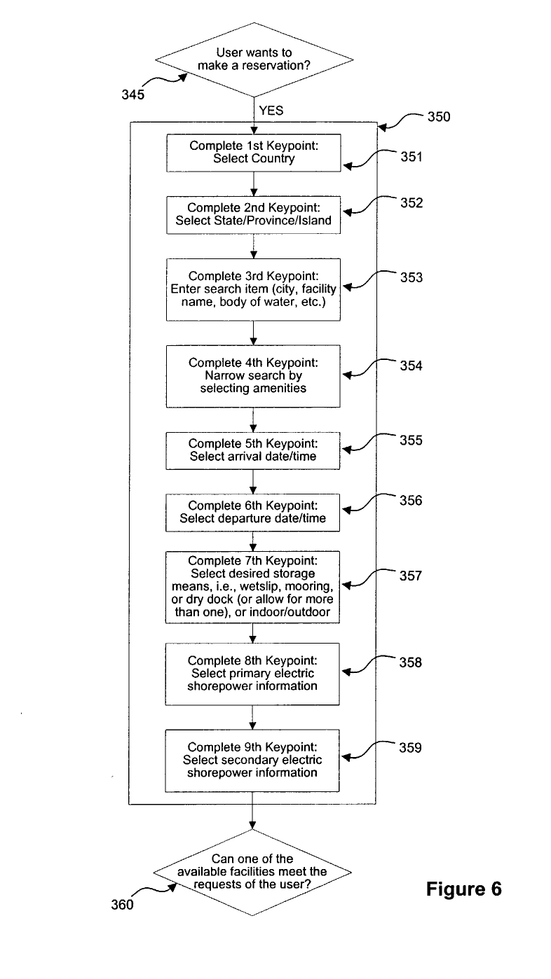

If it is determined 310 that the craft 105 is within the set of determined geographical locations 230 and the craft 105 has not yet been contacted to make a reservation 315, then the designated facility system 200 notifies 335 available facilities, identifying the craft 105 and notifying them that a qualified craft 105 is within the set of determined geographical locations 230, and also sends 340 a message 170 to the craft 105 inquiring whether the user 40 wants to make a dockage reservation 175. Further, the designated facility system 200 notifies 335 third parties that the craft 105 is within set of determined geographical locations 230. At this point the craft status is updated 342 to indicate that the user 40 has started a reservation transaction 175. If the user 40 decides 345 to make a reservation, then the user 40 completes 350 the reservation transaction keypoints. These keypoints and the operation of the system allowing the completion of the keypoints will be described in detail in conjunction with FIGS. 6, 7, and 8. After completing the keypoints, the designated facility system 200 determines 360 whether one of the available facilities may meet the requests of the user 40, and if so, the designated facility system 200 notifies 375 the acceptable facility that a user 40 has made a reservation and the craft system 100 updates 375 the status code 146 to indicate that the reservation transaction was completed. The notification 280 may be transmitted by means including but not limited to Internet messaging, wireless telephone, conventional telephone, e-mail, fax, e-fax, network messaging, a direct wireless connection, wired or wireless CCTV, and/or any other means, and may comprise audio, video, text, and/or any combination thereof. If an available facility cannot satisfy the requests of the user 40 then the user 40 is presented 362 with possible options closest to his or her requests, and has the choice of selecting one of the options or declining 365 to make a reservation. If the user 40 chooses an option, the acceptable facility is notified 375 as before and the status code 146 is updated 375 to indicate that the reservation transaction is complete; if the user 40 decides 365 not to make a reservation, then the status code 146 is updated 370 to indicate that the reservation transaction is complete. For example, with the use of watercraft, one of the keypoints may prompt the user 40 to specify whether he or she prefers a wetslip, dry dock, or mooring. If the user 40 enters dry dock, and after all the keypoints are completed it is determined that all requests of the user 40 can be satisfied with the exception that only wetslips or moorings are available, the designated facility system 200 will prompt the user 40 to select either a wetslip or mooring. The user 40 may then choose one of the available space types and make the reservation, or he may try to terminate the reservation. Note that this example serves only to illustrate one of the many functionalities of the craft communications, tracking and reservation system 10. If when first prompted to make a reservation the user 40 decides not to make one, then the status code 146 is updated 370 to indicate that the reservation transaction is complete.

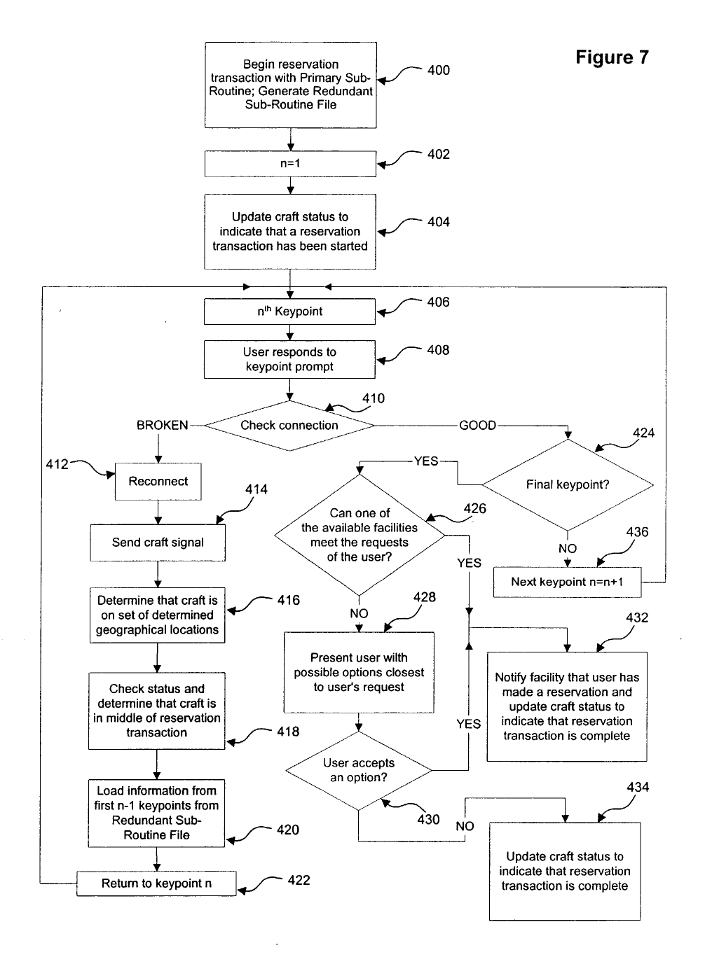

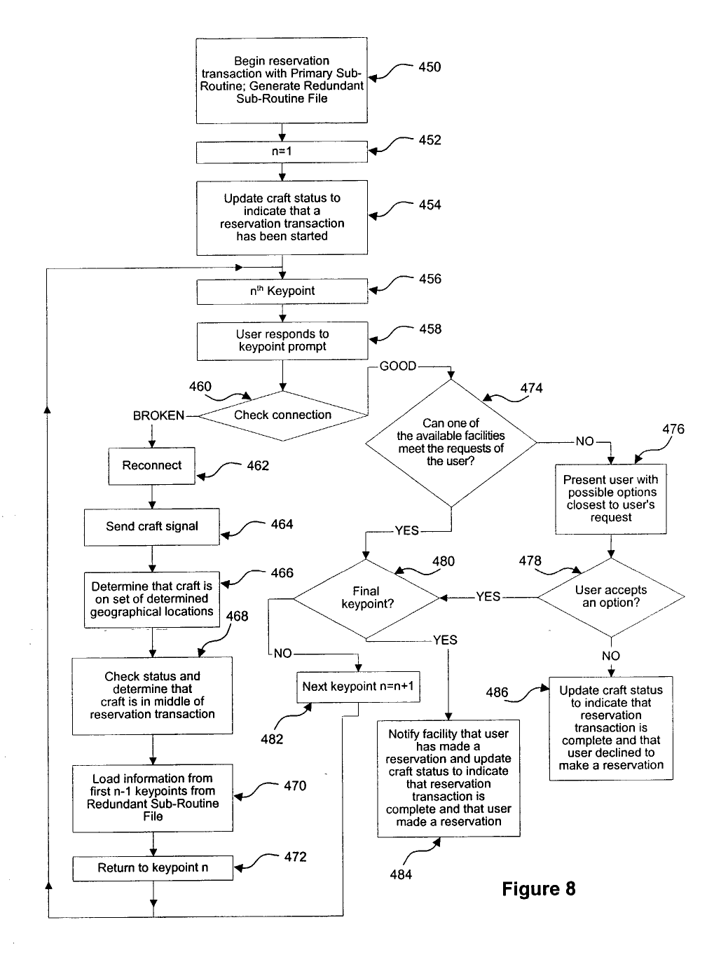

If it is determined 310 that the craft 105 is within the set of determined geographical locations 230 and it is determined 315 from the craft status that the craft 105 has already been contacted to make a reservation and further determined 320 that the craft 105 has not completed the reservation transaction 175, then the craft 105 is in the middle 325 of an interrupted reservation transaction 175. The transaction is continued 330 by a method that will be described in detail below in conjunction with FIGS. 7 and 8. Once the user 40 completes 350 the plurality of keypoints, the method proceeds as earlier with the designated facility system 200 determining 360 whether one of the available facilities may meet the requests of the user 40.

If it is determined 310 that the craft 105 is within the set of determined geographical locations 230 and it is determined 320 that the craft 105 has already completed the reservation transaction 175, then the craft 105 simply continues acquiring 302 its position 142 and transmitting 305 the algorithm 140 according to the predetermined criteria. Similarly, if it is determined 310 that the craft 105 is not within the set of determined geographical locations 230, the craft 105 continues acquiring 302 its position 142 and transmitting 305 the algorithm 140 according to the predetermined criteria. The predetermined criteria may vary depending on whether the craft 105 is within or outside the set of determined geographical locations 230.

Once the reservation transaction is complete, whether or not the user 40 makes a reservation, the messaging transaction commences. First, the designated facility system 200 checks 380 whether it has any messages to deliver to the user 40, such as messages from third parties or its own messages (i.e., those relating to a completed reservation), and if so, delivers 385 the messages. A message from the designated facility system 200 might be the best approach video stream discussed earlier. Third parties may include, but are not limited to, the craft owner, interested persons, or even hotels and/or restaurants. Messages may comprise audio, video, or text or any combination thereof. In addition, messages may also be transmitted for instance but not limited to via Internet messaging, wireless telephone, conventional telephone, e-mail, fax, e-fax, network messaging, a direct wireless connection, wired or wireless CCTV, and/or other means. A signal is then sent 387 notifying the sending parties that the messages were delivered. Whether or not there were any messages to deliver to the user 40, the user 40 is then presented with the option 390 to send any messages to third parties. If the designated facility system 200 is located at a facility, the user 40 may send messages for the facility directly to the designated facility system 200. After any user messages are sent 395, the messaging transaction is complete 398.

The reservation transaction keypoints 350 in one advantageous embodiment of the present invention, as applied to watercraft, are illustrated in FIG. 6. After deciding 345 to make a reservation, the user 40 is presented with the following keypoints in the order listed: Select Country 351; Select State/Province/Island 352; Enter search item (city, facility name, body of water) 353; Narrow search by selecting amenities 354; Select arrival date/time 355; Select departure date/time 356; Select wetslip, mooring, dry dock (or allow for more than one of the three) 357; Select primary electric shorepower information 358; and Select secondary electric shorepower information 359. After completing the final keypoint, the designated facility system 200 determines whether any of the available facilities can satisfy the requests of the user 40 360. Although these keypoints 350 are the ones used in this particular embodiment of the present invention, may other keypoints and combinations of keypoints may also be utilized, depending on the capabilities of the facility and the requirements of the user 40. It is also possible for the keypoints 350 to vary depending on the location and specifications of the craft 105.

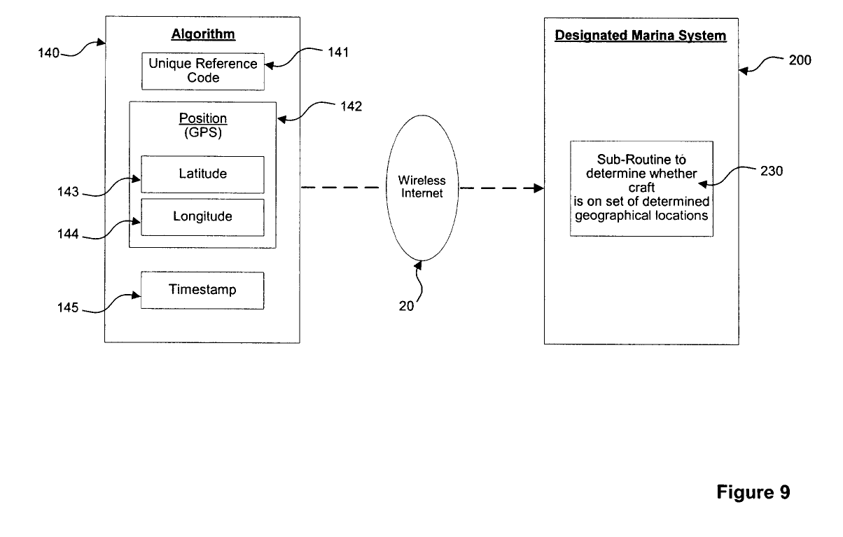

Referring now to FIG. 7. The reservation transaction begins 400 and the keypoint counter n is set to n=1 402. The craft status is updated 404 to indicate that the craft 105 is currently in the middle of making a reservation. If the algorithm 140 of FIG. 4 is used, the craft status is controlled by the status code 146. An alternative embodiment in which a craft signal without status information is used will be described below in conjunction with FIG. 9. At the nth keypoint 406, the designated facility system 200 prompts 408 the user 40 for a response. After the user 40 responds, the wireless Internet connection is checked 410. If the connection is determined to be good, the designated facility system 200 then checks 424 whether the current keypoint is the last keypoint. If it is not the last keypoint, then the designated facility system 200 commences 436 to the next keypoint. If it is the final keypoint, then the designated facility system 200 determines 426 whether it is possible to fulfill the request. If it is possible, then upon receiving notification that the reservation was accepted, the craft status is updated 432 to indicate that the reservation transaction is complete and the acceptable facility is notified 432 that the craft 105 has made a reservation there. If it is not possible to fulfill the request, the user 40 is presented 428 with possible options closest to his or her request. The user 40 makes a decision by accepting an option or declining 430 to make a reservation. If the user 40 accepts, the craft status is updated 432 to indicate that the reservation transaction is complete and the acceptable facility is notified 432. If the user 40 declines, the craft status is also updated 434 to indicate that the reservation is complete. After completing the reservation transaction, the user 40 may begin messaging transactions as discussed in conjunction with FIG. 5.

If when checking the connection 410 it is determined the connection was interrupted, it is necessary to reconnect 412. Once reconnected, the craft 105 again sends 414 the craft signal 140 to the designated facility system 200. Upon receiving the craft signal 140, the designated facility system 200 determines 416 whether the craft 105 is within the set of determined geographical locations 230. In another embodiment, the craft system database 120 stores the set of determined geographical locations 230 and reports to the facility as to whether the craft 105 is on the set of determined geographical locations 230. The designated facility system 200 then checks the craft status and determines 418 that the craft 105 was in the middle of a reservation transaction 175. The keypoint responses from the interrupted transaction are loaded 420 from the redundant sub-routine file, and the transaction between the user 40 and the primary sub-routine 210 resumes 422 at the nth keypoint, thereby reducing impact of the broken connection by resuming the transaction at the interrupted point. This will result in major timesavings for the user 40.

In the embodiment described in conjunction with FIG. 7, the designated facility system 200 queries the available facility systems to check whether an available facility can satisfy the requests of the user 40 after all of the keypoints of the reservation transaction are completed by the user 40. In an alternative advantageous embodiment, illustrated in FIG. 8, the check may be made after each keypoint. As before, the reservation transaction begins 450 and the keypoint counter n is set 452 to n=1. The craft status is updated 454 to indicate that the craft 105 is currently in the middle of making a reservation. When at the nth keypoint 456, the designated facility system 200 prompts 458 the user 40 for a response. After the user 40 responds, the wireless Internet connection is checked 460. If the connection is good, the designated facility system 200 determines 474 whether it is possible for one of the available facilities to fulfill the requests of the user 40. If it is possible, then the designated facility system 200 then determines 480 whether the current keypoint is the final keypoint. If it is not the last keypoint then the keypoint counter is incremented 482, and the transaction continues with the next keypoint 456. If it is the final keypoint, then the designated facility system 200 notifies 484 the acceptable facility that a user 40 made a reservation and the craft status is updated 484 to indicate that the reservation transaction is complete. Further, the craft status is updated 484 to indicate that the user 40 made a reservation.

If it is not possible for an available facility to fulfill the request of the user 40 474, then the user 40 is presented 476 with possible options closest to his or her request. If the user 40 accepts 478 the option, then the transaction continues as before by checking 480 to see if the current keypoint is the final keypoint. If the user 40 declines to make a reservation, then the status code 146 is updated 486 to indicate that the reservation transaction is complete, and optionally, that the user 40 declined to make a reservation. After completing the reservation transaction, the user 40 may complete the messaging transactions as discussed in conjunction with FIG. 5.

The method of resuming an incomplete transaction, represented by steps 460-472, is the same method as in the previous embodiment discussed in conjunction with FIG. 7 at steps 410-422, and therefore will not be repeated.

Note that in this particular embodiment the craft status is utilized to distinguish between craft that have made a reservation and those that have declined to make reservations. This allows the designated facility system 200 to perform location-based functions limited only to craft that have made reservations without having to query the designated facility system database 220 or the facility system databases 260, 261, . . . , and 262 of FIG. 1 to check whether a craft 105 with a given unique reference code 141 made a reservation. Also, it facilitates sending messages to the users 40 of all craft 105 that have made reservations. For instance, a restaurant owner may utilize this feature to attract those who have made reservations, and hence will be in the locality, to patronize their establishment. This particular feature may provide many advantages, as commercial establishments will pay for advertising. In addition, the messaging may even include, for instance, restaurant reviews or movie listings, time and locations. It is possible that many different types of messages may be sent and/or received in this manner.

In the embodiments discussed in conjunction with both FIG. 7 and FIG. 8, the user 40 completed one keypoint at time, and then the craft system 100 sent the response to the designated facility system 200. It is also conceivable that the user 40 will complete more than one keypoint on the craft system 100 before sending the responses to the designated facility system 200 over the wireless Internet connection. It is even foreseeable that the user 40 will respond to all keypoints locally, the responses being logged in the redundant sub-routine file, which is then sent to the designated facility system 200. In that case, in order for the user 40 to make a reservation, the wireless Internet connection does not have to be active while the user 40 is formulating responses to the keypoints; it only has to be active when the redundant sub-routine file is being transferred.

As stated above, it is possible to use a craft signal without status information. Algorithm 150 of FIG. 9 illustrates this craft signal, and comprises unique reference code 141; position 142, including latitude 143 and longitude 144; and timestamp 145. Instead of having a status code 146, like in algorithm 140, in this embodiment the craft status is stored in the designated facility system database 220 and indexed by the unique reference code 141 of the craft 105. That way, upon determining that the craft 105 with a given unique reference code 141 is in the set of determined geographical locations 230, the designated facility system 200 can query the designated facility system database 220 for the status of the craft 105.

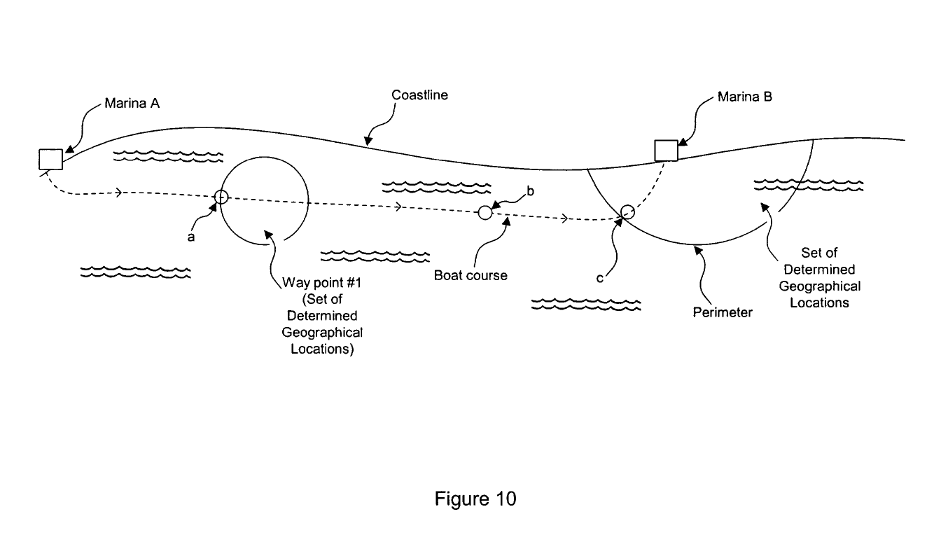

FIG. 10 is an illustration that traces the path of a possible watercraft voyage from marina A to marina B. Throughout the course the craft 105 is sending the algorithm 150 according to predetermined criteria. When the craft 105 reaches position “a,” the designated facility system 200 determines that the craft 105 is on the set of determined geographical locations 230 corresponding to waypoint #1. In a further embodiment the craft system 100 may determine that the craft 105 is on the set of determined geographical locations 230 and report this information to the designated facility system 200 as part of the algorithm 150. At this point the designated facility system 200 may take any number of actions, including but not limited to sending messages to third parties notifying them of the location of the craft 105. When the craft 105 reaches position “b,” the craft 105 is still sending the algorithm 150 according to predetermined criteria, but no special action is being taken by the craft system 100 or the designated facility system 200. The designated facility system 200 determines that the craft 105 is within a set of determined geographical locations 230 when the craft 105 reaches point “c,” and it may send a message to the craft 105 prompting the user 40 to indicate if he or she wants to make a reservation. If the user 40 desires to make a reservation at marina B, the user 40 may specify that when completing the appropriate keypoint. Throughout the craft 105 course, the communications between the craft system 100 and designated facility system 200, including instances of the craft 105 transmitting the algorithm 150, messages, and the keypoints of the reservation transaction, may be logged in a voyage record file.

It should be noted that the embodiments of the craft communications, tracking and reservation system previously described may be activated and deactivated as desired, or certain aspects of various embodiments may be selectively activated or deactivated. For instance, a user 40 may not want to utilize the system on a particular voyage, or perhaps he or she will want the GPS functionality but will not want to send his or her location to the designated facility system 200, nor have the voyage recorder log the trip. Precautions may be taken, however, limiting the control the user 40 has in activating and deactivating features of the system. For example, it may be desired to allow the user 40 no control over whether the voyage recorder is operating, such that the craft 105 may be continuously monitored to, for instance, determine and ensure the craft 105 stays on the proper course heading.

The disclosed embodiments of the present invention may also incorporate features known to those skilled in the art. For example, a user 40 may desire to integrate a security system or one-touch emergency buttons into the system. The one-touch emergency buttons can be used to contact any number of emergency service personnel such as the police, firefighters, coast guard, or towing/repair services, and activating the system could initiate a live conversation, or send messages using the previously described third party messaging functionality.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A craft communication apparatus for automatically communicating with a craft, the apparatus comprising:
a craft system;
a craft system database accessible by said craft system for storing information related to the craft;
a facility system;
a facility system database accessible by said facility system for storing information related to a facility;
a communication link for connecting said craft system to said facility system;
an algorithm transmitted by said craft system to said facility system, the algorithm including:
a unique identification code for identifying the craft;
a location of the craft;
a timestamp; and
a status code;
a set of determined geographical locations;
a facility signal transmitted by said facility system to said craft system subsequent to said facility system determining that the craft is within said set of determined geographical locations, for communicating messages to said craft system and for initiating a reservation transaction; and
a redundant sub-routine file to log the reservation transaction;
wherein if the connection between said craft system and said facility system is interrupted, upon reconnection, said redundant sub-routine file is automatically loaded onto said facility system such that the reservation transaction begins at a point in the transaction where the interruption occurred.

2. A craft communication apparatus for automatically communicating with a craft, the apparatus comprising:
a craft system;
a craft system database accessible by said craft system for storing information related to the craft;
a facility system;
a communication link for connecting said craft system to said facility system; and
an algorithm transmitted by said craft system to said facility system including a unique identification code for identifying the craft and a location of the craft.

3. The craft communication apparatus of claim 2 wherein said algorithm further comprises a timestamp.

4. The craft communication apparatus of claim 2 wherein said algorithm further comprises a status code.

5. The craft communication apparatus of claim 2 further comprising:
an additional facility system; and
a communications link for connecting said additional facility system to said facility system.

6. The craft communication apparatus of claim 5 further comprising an identification signal transmitted by said facility system to said additional facility system identifying the craft, subsequent to the facility system determining that the craft is within a set of determined geographical locations.

7. The craft communication apparatus of claim 2 further comprising a communication signal transmitted by said facility system to said craft system for initiating communication with said craft system.

8. The craft communication apparatus of claim 2 further comprising a communication link for connecting a third party to said facility system, and for sending a third party message to said craft system via said facility system.

9. The craft communication apparatus of claim 8 further comprising a notification/communication signal transmitted by said facility system to the third party for notifying the third party that the third party message has been delivered to said craft system and for delivering a craft message to the third party.

10. The craft communication apparatus of claim 2 further comprising a set of determined geographical locations.

11. The craft communication apparatus of claim 10 further comprising a reservation request signal transmitted by said facility system to said craft system subsequent to said facility system determining that the craft is within said set of determined geographical locations for initiating a reservation transaction.

12. The craft communication apparatus of claim 11 wherein the reservation transaction comprises a keypoint.

13. The craft communication apparatus of claim 2 wherein said communication link comprises a wireless Internet connection.

14. The craft communication apparatus of claim 13 wherein said wireless Internet connection comprises a Mobile Virtual Network.

15. The craft communication apparatus of claim 2 wherein the unique identification code comprises a registration number of the craft.

16. The craft communication apparatus of claim 2 wherein the unique identification code enables said facility system to determine the length, beam, and draft of the craft.

17. The craft communication apparatus of claim 2 wherein the location of the craft comprises a longitude and latitude of the craft.

18. The craft communication system of claim 2 wherein said craft system utilizes a video display as a user interface.

19. The craft communication apparatus of claim 2 wherein said craft system includes CCTV capability.

20. The craft communication apparatus of claim 2 wherein said craft system utilizes audio signals as a user interface.

21. The craft communication apparatus of claim 2 wherein said craft system includes speech recognition means enabling a user to utilize said craft system by issuing verbal instructions.

22. The craft communication apparatus of claim 2 further comprising message transmission means, to facilitate transmission of messages between said craft system and a third party, said message transmission means selected from the group consisting of: Internet messaging, wireless and conventional telephones, e-mail, fax, e-fax, network messaging, direct wireless connections, and wireless and conventional CCTV.

23. The craft communication apparatus of claim 2 further comprising an electronic plan filed by a user of said craft system.

24. The craft communication apparatus of claim 23 wherein said electronic plan comprises a waypoint at which a notification message is sent to a third party.

25. The craft communication apparatus of claim 24 wherein the notification message indicates the location of the craft.

26. The craft communication apparatus of claim 2 further comprising a metering means for charging a user account.

27. The craft communication system of claim 26 wherein said metering means comprises a timestamp.

28. The craft communication apparatus of claim 2 further comprising a voyage record file for logging communications between said craft system and said facility system.

29. A craft communication apparatus for automatically communicating with a craft, the apparatus comprising:
a craft system;
a location system, for identifying a position of the craft;
a facility system;
a facility system database accessible by said facility system for storing information related to a facility;
a communication link for connecting said craft system to said facility system;
a set of determined geographical locations;
a reservation request signal transmitted by said facility system to said craft system subsequent to said facility system determining that the craft is within said set of determined geographical locations for initiating a reservation transaction; and
a redundant sub-routine file to log the reservation transaction;
wherein if the connection between said craft system and said facility system is interrupted, upon reconnection, said redundant subroutine file is automatically loaded onto said facility system such that the reservation transaction begins at a point in the transaction where the interruption occurred.

30. The craft communication apparatus of claim 29 further comprising:
an additional facility system; and
a communications link for connecting said additional facility system to said facility system.

31. The craft communication apparatus of claim 29 wherein said communications link further enables a third party to communicate with said craft system via said facility system.

32. The craft communication apparatus of claim 31 further comprising a notification/communication signal transmitted by said facility system to the third party for notifying the third party that the third party message has been delivered to the craft system and for delivering a craft message to the third party.

33. The craft communication system of claim 29 wherein the reservation request transaction comprises a keypoint.

34. The craft communication system of claim 33 wherein said redundant sub-routine file comprises a log of keypoint transactions completed by a user.

35. The craft communication system of claim 29 wherein said redundant sub-routine file is stored on said craft system database.

36. The craft communication system of claim 29 wherein said communication link comprises a wireless Internet connection.

37. The craft communication system of claim 36 wherein said wireless Internet connection is a Mobile Virtual Network.

38. The craft communication system of claim 29 further comprising message transmission means, to facilitate transmission of messages between said craft system and a third party, said message transmission means selected from the group consisting of: Internet messaging, wireless and conventional telephones, e-mail, fax, e-fax, network messaging, direct wireless connections, and wireless and conventional CCTV.

39. A method for automatically communicating with a craft comprising the steps of:
determining the position of the craft;
determining if the craft is within a set of determined geographical locations;
establishing a communications connection and transmitting messages between a craft system and a facility system upon determining that the craft is within the set of determined geographical locations; and
logging the communications in a voyage record file.

40. The method of claim 39 further comprising the steps of:
initiating a reservation transaction between the craft system and the facility system; and
logging the reservation transaction in a redundant sub-routine file;
wherein if the connection between the craft system and the facility system is interrupted, upon reconnection, the redundant subroutine file is automatically loaded onto the facility system such that the reservation transaction begins at a point in the transaction where the interruption occurred.

41. A method for automatically communicating with and determining the position of a craft comprising the steps of:
determining the position of the craft;
uniquely identifying the craft by means of a unique identification code;
establishing a set of determined geographical locations;
determining if the craft is within the set of determined geographical locations;
establishing a communications connection between the craft and a facility system subsequent to determining that the craft is within the set of determined geographical locations; and
transmitting messages between the craft and the facility system wherein the unique identification code is utilized to transmit craft-specific messages to and from the craft.

42. The method of claim 41 wherein the communications connection between the craft and the facility system facilitates transmission of third party messages to and from the craft via the facility system.

43. A craft communication apparatus for automatically communicating with a craft, the apparatus comprising:
a craft system;
a craft system database accessible by said craft system for storing information related to the craft;
a location system, for identifying the position of the craft;
a facility system;
a facility system database accessible by said facility system for storing information related to a facility;
a communication link for connecting said craft system to said facility system;
a set of determined geographical locations; and
a facility signal transmitted by said facility system to said craft system subsequent to determining that the craft is within said set of determined geographical locations, for initiating the transmission of two-way messages between said craft system and said facility system.

44. A craft communication apparatus for automatically communicating with a craft, the apparatus comprising:
a craft system;
a craft system database accessible by said craft system for storing information related to the craft;
a location system, for identifying the position of the craft;
a facility system;
a facility system database accessible by said facility system for storing information related to a facility;
a communication link for connecting said craft system to said facility system;
a set of determined geographical locations;
a position means for determining if the craft is within said set of determined geographical locations; and
an identification means for uniquely identifying the craft.
